(19) United States
(12) Patent Application Publication
(10) Pub. No.: US 2011/0280361 A1
(43) Pub. Date: Nov. 17, 2011

(54) LOWER NOZZLE FOR NUCLEAR FUEL ASSEMBLY FOR PRESSURIZED WATER REACTOR

(75) Inventors: Mattias Rudolph, Weisendorf (DE); Erhard Friedrich, Eckental (DE); Hintergräber Christian, Nurnberg (DE); Uwe Lange, Rodgau (DE)

(73) Assignee: AREVA NP, Courbevoie (FR)

(21) Appl. No.: 13/128,598

(22) PCT Filed: Nov. 9, 2009
(86) PCT No.: PCT/EP2009/064856

§ 371 Date: Jul. 26, 2011

(30) Foreign Application Priority Data
Nov. 12, 2008 (EP) 08305799.2

(51) Int. Cl. G21C 3/34; G21C 15/00

(52) U.S. Cl. 376/438; 376/399

(57) ABSTRACT

A lower nozzle an upper end and a lower end for the lower nozzle to rest on a lower core plate of a reactor core and a lateral surface extending along a longitudinal axis from the lower end to the upper end.

The lateral surface including a longitudinal segment tapering downwardly progressively and continuously along the longitudinal axis and extending on at least 50% of the height of the lateral surface.

The present invention relates to a lower nozzle for nuclear fuel assembly for use in a pressurized water reactor, of the type comprising an upper end and a lower end for the lower nozzle to rest on a lower core plate of a reactor core and a lateral surface extending along a longitudinal axis from the lower end to the upper end.

### BACKGROUND

A nuclear fuel assembly for use in a pressurized water reactor (PWR) conventionally comprises a bundle of fuel rods supported by a structure comprising a lower nozzle (or lower tie plate) and an upper nozzle (or upper tie plate) spaced in a longitudinal direction and connected only by longitudinal tubes, the fuel rods being supported by spacer grids secured to the tubes.

In use, fuel assemblies are arranged in an array in the core of a nuclear reactor. Each fuel assembly is inserted vertically between adjacent assemblies.

The fuel assembly is elongated, typically of approximately 4 to 5 meters high and 20 to 25 centimeters wide, and may bend along its length due to the operating conditions inside the reactor core and/or to the flexibility of its structure.

During insertion of a fuel assembly between adjacent other assemblies, such bending increases the risk that the lower nozzle of the fuel assembly will contact the adjacent fuel assemblies, increasing the friction and thus complicating the insertion and possibly damaging the fuel assemblies.

It may even occur that the lower nozzle of the fuel assembly abuts the lower nozzle of an adjacent fuel assembly thus preventing full insertion of the fuel assembly.

In such case, it is possible to lift up the assembly, rotate the fuel assembly around a longitudinal axis (for example of 90° or 180° for fuel assembly of a square cross-section) and insert the fuel assembly downwardly again. However, such operations are time consuming.

### SUMMARY OF THE INVENTION

An object of the invention is to provide a lower nozzle allowing improving easiness and safety during insertion of a fuel assembly into a reactor core.

To this end, the invention provides a lower nozzle of the above mentioned type, wherein the lateral surface comprises a longitudinal segment tapering downwardly progressively and continuously along the longitudinal axis and extending on at least 50% of the height of the lateral surface.

In other embodiments, the lower nozzle comprises one or several of the following features, taken in isolation or in any technically feasible combination:

the tapered longitudinal segment tapers downwardly continuously and progressively in side view in any transverse direction perpendicular to the longitudinal axis;

the tapered longitudinal segment tapers symmetrically relative to the longitudinal axis;

the tapered longitudinal segment is ruled;

the tapered longitudinal segment is conical;

the tapered longitudinal segment is of polygonal transverse cross-section, namely of quadratic or hexagonal transverse cross-section;

the half cone angle of the tapered longitudinal lower segment is comprised between 0.5° and 15°;

the tapered longitudinal lower segment extends on at least 70% of the height of the lateral surface;

the lateral surface comprises a cylindrical upper segment extending the tapered longitudinal lower segment upwardly to the upper end; and

a tubular water inlet extending the lower nozzle along the longitudinal axis downwardly from the lower end, the water inlet having an outer surface of tapering downwardly progressively and continuously.

The invention also provides a nuclear fuel assembly for use in a pressurized water reactor, comprising a bundle of elongated fuel rods and a structure for supporting the fuel rods, the structure comprising a lower nozzle and an upper nozzle spaced longitudinally, guide tubes connecting between the nozzles and spacer grids secured to and distributed along the length of the guide tubes, the fuel rods being supported by the spacer grids.

### BRIEF DESCRIPTION OF THE DRAWINGS

The invention and its advantages will be better understood on reading the following description given solely by way of example and with reference to the appended drawings, in which:

FIG. 1 is a schematic side elevation view of a fuel assembly having a lower nozzle according to the invention;

FIG. 2 is an enlarged view of the lower nozzle of the fuel assembly of FIG. 1;

FIG. 3 is a bottom view of the lower nozzle of FIG. 2;

FIG. 4 is a view illustrating positioning of the fuel assembly of FIG. 1 into a reactor core; and

FIGS. 5 and 6 are views similar to that of FIGS. 2 and 3 of a lower nozzle according to another embodiment.

### DETAILED DESCRIPTION

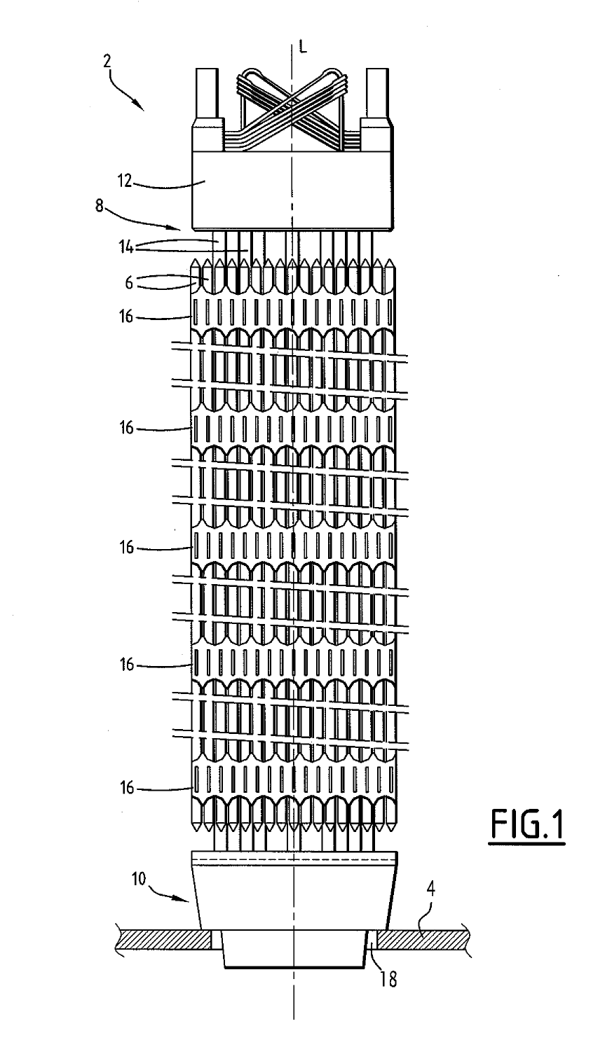

The fuel assembly 2 of FIG. 1 is elongated and extends along a longitudinal direction L.

In use, the fuel assembly 2 is intended to be inserted inside a reactor core and to rest on a lower core plate 4 with the longitudinal direction L oriented vertically. In the following, the terms relating to orientation, such as downward, upward . . . , refer to the longitudinal direction L extending vertically.

The fuel assembly 2 comprises a bundle of fuel rods 6 elongated along the longitudinal direction L and a structure 8 for supporting the fuel rods 6.

The structure 8 comprises a lower nozzle 10 and an upper nozzle 12 spaced longitudinally, guide tubes 14 extending longitudinally between the lower nozzle 10 and the upper nozzle 12 and spacer grids 16 distributed along the guide tubes 14 between the lower nozzle 10 and the upper nozzle 12.

The upper nozzle 12 is adapted for lifting up the fuel assembly 2 using a clamp.

The guide tubes 14 connect the lower nozzle 10 to the upper nozzle 12 and maintain the longitudinal spacing between them. The lower nozzle 10 and the upper nozzle 12 are connected only by the guide tubes 14.

The guide tubes 14 are tubular for allowing insertion of cluster rods which do not contain fissile material inside the guide tubes 14 through the upper nozzle 12.

Each spacer grid 16 extends transversally and defines a lattice of cells for receiving the guide tubes 14 and the fuel rods 6. The fuel rods 6 extend through the cells and are supported by the spacer grids 16.

In use, the fuel assembly 2 rests via the lower nozzle 10 on the lower core plate 4 above a coolant fluid inlet opening 18 of the lower core plate 4. The lower nozzle 10 supports the fuel assembly 2 and allows coolant fluid to flow vertically upwardly through the lower nozzle 10.

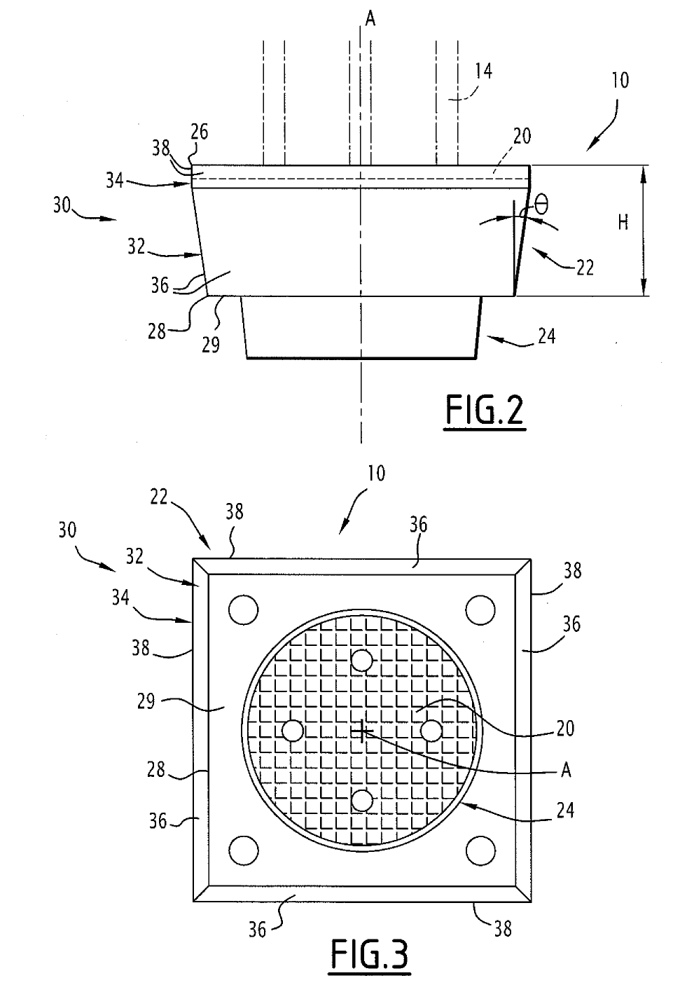

As illustrated in FIGS. 2 and 3, the lower nozzle 10 comprises an upper plate 20, a tubular base 22 extending downwardly along a longitudinal axis A from the periphery of the upper plate 20 and a tubular inlet 24 extending the base 22.

The base 22 extends longitudinally between an upper end 26 and a lower end 28. The upper end 26 and the lower end 28 have square outlines centred on the longitudinal axis A and the length of the outer edges of the lower end 28 is inferior to that of the upper end 26.

The upper plate 20 extends transversely at the upper end 26 of the base 22 and is adapted for connecting the guide tubes 14 (represented in dotted line on FIG. 2) and has openings for allowing coolant fluid flow through the upper plate 20.

The lower end 28 is intended to rest against the lower core plate 4 at the periphery of an opening 18. The base 22 is provided at the lower end 28 with a bearing surface 29 extending transversely to the longitudinal axis A. The bearing surface 29 is symmetric around the longitudinal axis A.

The lower nozzle 10 has a lateral surface 30 extending between the outer periphery of the lower end 28 and the outer periphery of the upper end 26. The lateral surface 30 is axisymmetric around the longitudinal axis A.

The lateral surface 30 comprises a longitudinal lower segment 32 (or part or section) immediately adjacent the lower end 28, and one longitudinal upper segment 34 (or part or section) extending upwardly from the upper extremity of the lower segment 32, up to the upper end 26.

The lower segment 32 is of reversed pyramidal shape and comprises four inclined faces 36 converging downwardly along the longitudinal axis A. Each inclined face 36 is inclined relative to the longitudinal axis A at an angle θ comprised between 0.5° and 15°.

The pyramid shaped lower segment 32 is conical and the inclination of each inclined face 36 relative to the longitudinal axis A equals the half-cone angle of the lower segment 32.

The lower segment 32 has transverse dimensions decreasing progressively and continuously downwardly along the longitudinal axis A.

The lower segment 32 tapers downwardly progressively and continuously in side view in any direction perpendicular to the longitudinal axis A, symmetrically relative to the longitudinal axis A.

The lower segment 32 extends on at least 50% the height H of the lateral surface 30 taken along the longitudinal axis A between the lower end 28 and the upper end 26, preferably at least 70%.

The upper segment 34 is cylindrical around the longitudinal axis A. It has a constant square transverse cross-section corresponding to the outline of the upper end 26. The upper segment 34 comprises four flat longitudinal faces 38 parallel to the longitudinal axis A.

The inlet 24 extends downwardly along the longitudinal axis A from the lower end 28 of the base 22. The inlet 24 is conical of circular transverse cross-section and downwardly converging.

The fuel assembly 2 might bend along the longitudinal direction L due to severe operating conditions and its structure 8 in which the lower nozzle 10 and the upper nozzle 12 are connected by the guide tubes 14 only.

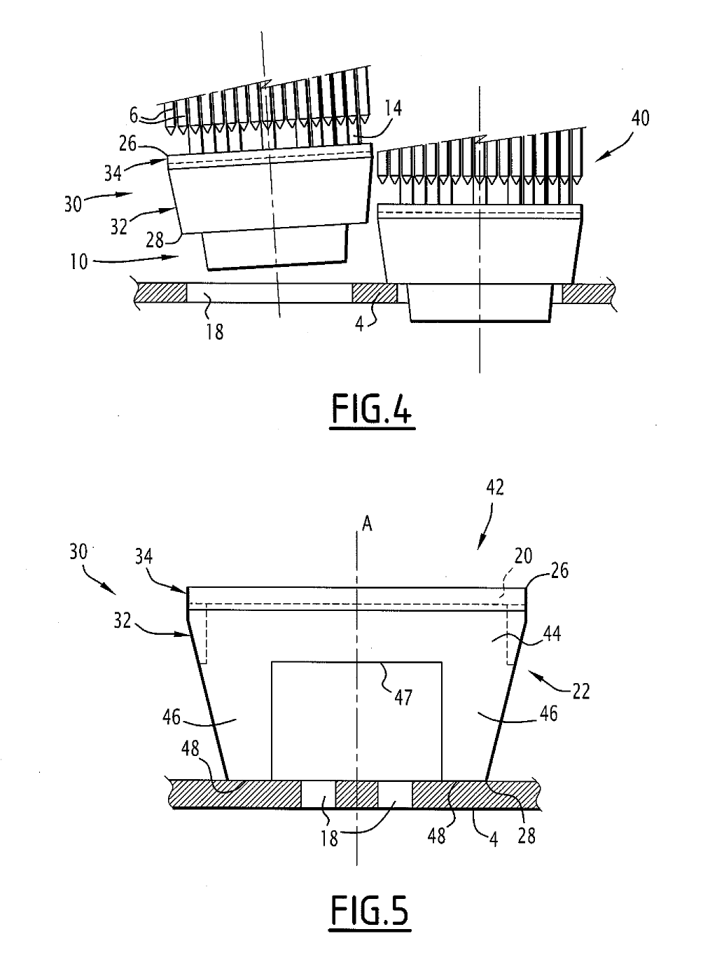

During insertion of the fuel assembly 2 beside an adjacent fuel assembly 40, the fuel assembly 2 is lifted down with controlling the position of the upper nozzle 12. However, as illustrated on FIG. 4, the lower nozzle 10 may offset laterally and/or be inclined relative to the vertical direction due to the bending and might abut by its lower end 28 or grate by its lateral surface 30 against the lower nozzle of the adjacent fuel assembly 40.

The lower end 28 having an outline of smaller transverse dimensions than that of the upper end 26 limits the risk that the lower end 28 will abut the lower nozzle of the adjacent fuel assembly 40.

The tapered lower segment 32 limits the risk of grating with the lower nozzle of the adjacent fuel assembly 40. Any contact will be delayed in the stroke of the downward movement of the fuel assembly 2 and progressive thus limiting the risk of damages. Any gratings will occur on a reduced longitudinal stroke.

The continuous and progressive tapering of the lower segment 32 ensures that the lower segment 32 is smooth and has no protruding abutment portion.

The extension of the tapered lower segment 32 on a significant portion of the height H of the lower nozzle 10 allows maintaining sufficient transverse dimensions for the bearing surface 29 of the lower end 28 which has to support the weight of the fuel assembly 2 while allowing significant reduction of abutment risks and grating risks.

In an example, the height H of the lower nozzle 10 taken between the lower end 28 and the upper end 26 is of approximately 105 mm, and the height of the tapered lower segment 32 is of 100 mm.

The conical inlet 24 provide similar advantages with respect to the edge of the opening 18 of the lower core plate 4 into which the inlet 24 is inserted during positioning of the fuel assembly 2 into the reactor core.

The upper segment 34 having faces 38 parallel to the longitudinal axis A allows creating a narrow passage having an important flow resistance between the adjacent lower nozzles which can limit the flow of coolant fluid flowing between the adjacent lower nozzles and bypassing the fuel assemblies.

The proportion of the lower segment relative to the upper segment is chosen to lower abutment and grating risks or consequences while limiting coolant fluid flows bypassing the fuel assemblies.

On FIG. 5, the numeral references of FIGS. 1-4 are used for the similar elements.

The lower nozzle 42 of FIG. 5 differs from that of FIG. 1-4 by the feature that the base 22 comprises a tubular skirt 44 extending downwardly from the periphery of the upper plate 20 and four corner feet 46 each extending downwardly from a respective corner of the skirt 44 (only two feet 46 are visible on FIG. 5).

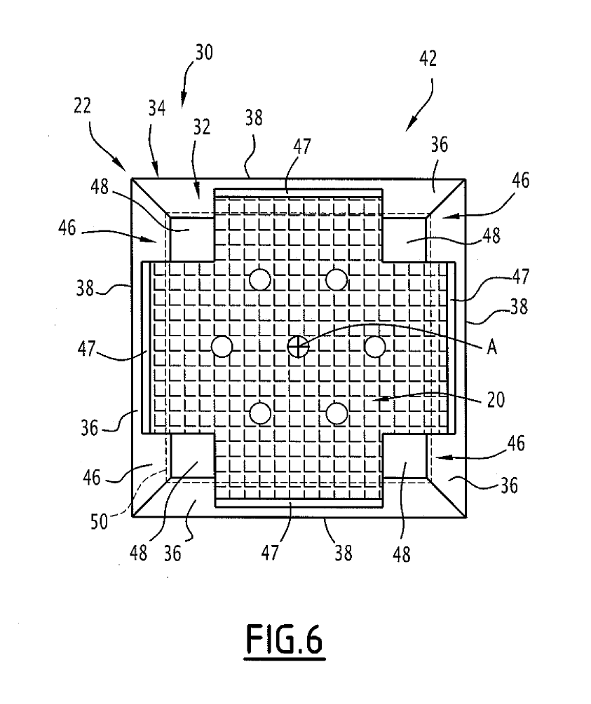

Each pair of feet 46 defines with the lower edge 47 of the skirt 44 a lateral opening. Each foot 46 is provided at its lower end 48 with a lower bearing face for resting onto a lower core plate 4. The lower ends 48 of the feet 46 define the lower end 28 of the base 22. The lower end 28 has a square outline 50 (represented in dash-doted lines on FIG. 6).

The lateral surface 30 of the lower nozzle 42 extends on the feet 46 and on the skirt 44. The lateral surface 30 exhibits an overall reverse pyramidal shape and comprises a downwardly tapering lower segment 32 of downwardly decreasing square cross-section having four faces 36 and a cylindrical upper segment 34 of constant square cross-section.

The lower segment 32 extends longitudinally from the lower end 28 up to a level above the lower edge 47 of the skirt 44 and the upper segment 34 extends in the remaining portion of the skirt 44. In an alternative, the lower segment 32 extends to a level below the skirt 44.

The upper face and the lower face of the lower nozzle are not limited to square outlines as illustrated in the embodiments of FIGS. 1-4 and 5.

In a variant for fuel assemblies of hexagonal transverse cross-section, the lower nozzle has an upper face and a lower face of hexagonal outlines and the tapered segment of the lateral surface has a reversed pyramidal shape of hexagonal base with faces inclined relative to the longitudinal axis A.

More generally, the lower nozzle has transverse cross-section of polygonal outline and the tapered segment of the lateral face of the lower nozzle is of reversed pyramidal shape with its faces inclined relative to the longitudinal axis A.

The tapered segment is not limited to conical surfaces such as pyramid shaped surfaces and may be more generally a ruled surface.

In a variant, the lower nozzle has an upper surface of polygonal outline (e.g. hexagonal outline), a lower surface of circular outline and the tapered segment is a ruled surface defined by rectilinear lines passing by a polygonal outline and a circular outline, the rectilinear lines being inclined inwardly and downwardly relative to the longitudinal axis A.

The tapered segment is not limited to ruled surface and may exhibit concavity or convexity in the longitudinal direction.

In a general manner, the tapered segment tapers downwardly continuously and progressively in side view in any transverse direction perpendicular to the longitudinal axis A, preferably symmetrically relative to the longitudinal axis A of the lower nozzle.

What is claimed is:

1-11. (canceled)

12. A lower nozzle for a nuclear fuel assembly for use in a pressurized water reactor, the lower nozzle comprising: an upper end and a lower end for the lower nozzle to rest on a lower core plate of a reactor core; and a lateral surface extending along a longitudinal axis from the lower end to the upper end, wherein the lateral surface comprises a longitudinal segment tapering downwardly progressively and continuously along the longitudinal axis and extending on at least 50% of a height of the lateral surface.

13. The lower nozzle according to claim 12 wherein the tapered longitudinal segment tapers downwardly continuously and progressively in a side view in any transverse direction perpendicular to the longitudinal axis.

14. The lower nozzle according to claim 12 wherein the tapered longitudinal segment tapers symmetrically relative to the longitudinal axis.

15. The lower nozzle according to claim 12 wherein the tapered longitudinal segment is ruled.

16. The lower nozzle according to claim 12 wherein the tapered longitudinal segment is conical.

17. The lower nozzle according to claim 16 wherein the tapered longitudinal segment is of a polygonal transverse cross-section.

18. The lower nozzle according to claim 16 wherein the conical taper longitudinal segment has a half cone angle between 0.5° and 15°.

19. The lower nozzle according to claim 12 wherein the tapered longitudinal segment extends on at least 70% of the height of the lateral surface.

20. The lower nozzle according to claim 12 wherein the lateral surface further comprises a cylindrical segment extending the tapered longitudinal segment upwardly to the upper end.

21. The lower nozzle according to claim 12 further comprising a tubular water inlet extending the lower nozzle along the longitudinal axis downwardly from the lower end, the water inlet having an outer surface tapering downwardly progressively and continuously.

22. A nuclear fuel assembly for use in a pressurized water reactor, the fuel assembly comprising a bundle of elongated fuel rods and a structure for supporting the fuel rods, the structure comprising a lower nozzle and an upper nozzle spaced longitudinally, guide tubes connecting between the upper and lower nozzles and spacer grids secured to and distributed along the length of the guide tubes, the fuel rods being supported by the spacer grids, wherein the lower nozzle is a lower nozzle according to claim 12.

23. The lower nozzle according to claim 17 wherein the polygonal traverse cross section is a quadratic or a hexagonal transverse cross-section.
